(19) United States
(12) Patent Application Publication
(10) Pub. No.: US 2006/0134585 A1
(43) Pub. Date: Jun. 22, 2006

(54) Interactive animation system for sign language

(76) Inventors: Nicoletta Adamo-Villani, Carmel, IN (US); Gerardo Beni, Riverside, CA (US); Ronnie Wilbur, Lafayette, IN (US); Marie A. Nadolske, West Lafayette, IN (US)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 11/216,606

(22) Filed: Aug. 31, 2005

Related U.S. Application Data
(60) Provisional application No. 60/606,298, filed on Sep. 1, 2004.
(60) Provisional application No. 60/606,300, filed on Sep. 1, 2004.

(51) Int. Cl. G09B 21/00

(52) U.S. Cl. 434/112

(57) ABSTRACT

A method and system for interactive communication in sign language using computer animation. In one aspect, a user interface is provided with a first activity area and a second activity area. A three-dimensional avatar configured to communicate using sign language is displayed between the first activity area and the second activity area. In response to the user selection of a respective one of the activity areas, the avatar is directed to sign an expression associated with the selected activity area. In another aspect, a method of teaching mathematics using sign language is provided. According to another aspect, a method of animating a signed communication is provided. In another aspect, a method of creating an animation of a sign language expression is provided.

### PRIORITY CLAIM

This application claims the benefit of U.S. Provisional Application No. 60/606,298, filed Sep. 1, 2004 and U.S. Provisional Application No. 60/606,300, filed Sep. 1, 2004, the entire disclosures of which are hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Technical Field

The present invention relates to a method of computer programming and animation with teaching applications.

2. Background Information

Research demonstrates that individuals who are deaf are significantly underrepresented in the fields of science and engineering. Studies also show that, historically, it has been difficult for these individuals to gain entry into courses in schools of higher education that lead to such careers. There are several factors contributing to this disparity: (1) A significant delay in deaf children's reading comprehension: 50% of students who are deaf leave high school with a reading level for English text that is below the fourth grade. (2) The difficulty of (hearing) parents to convey in sign language basic science/mathematical concepts. There are currently no tools for learning efficiently signs related to mathematical concepts. (3) The inaccessibility to incidental learning (exposure to media in which mathematical concepts are practiced and reinforced). Deaf youngsters lack access to many sources of information (e.g., radio, conversations around the dinner table) and their incidental learning may suffer from this lack of opportunity.

Mathematics is essential for science, technology and engineering, but above all, for developing thinking abilities. If mathematical thinking is not developed early the mind may never catch up. Some concepts (foremost mathematical concepts) that hearing children learn incidentally in everyday life may have to be explicitly taught to deaf pupils in school. An example is the concept that a number can be seen as the sum of other numbers.

Assuming a best possible case (very rare) scenario, by grade 8th, a deaf child has mastered 8th grade reading ability in English; with this ability she can bypass sign language and learn from mathematics books written in English. But before she can do this she must rely on sign language and for sign language she has to constantly rely on interpreters. A deaf student can learn quite effectively under two conditions (neither of which applies to K-8): (1) the deaf student can read English and (2) the deaf student has access to real time close captioning in English. For these two conditions to be realized, a successful transition from American Sign Language (ASL) to English must take place. The time for this transition is K-8. Thus, there is a need for bilingualism in grades K-8.

In an ideal case, the transition from ASL to English would take place in three phases: infancy to K (ASL); K-8 (ASL, Signed English (SE) and English); high-school and beyond (English). The human interpreter is likely irreplaceable in phase I, and real time close captioning is the most efficient choice in phase III. Thus, the most critical need for the tools of bilingualism is in phase II.

From this follows the crucial importance of sign language for the basic concepts of arithmetic, geometry and elementary algebra. However, standard sign language dictionaries do not even list the most basic concepts of elementary algebra.

Compounding the necessity for mathematics signs is the recent and growing practice of delivering curriculum and software online. These text-based instructional materials—both written and voiced—provide a vast array of content information, problem solving strategies, and help information that offer opportunities to probe questions, share and compare data, and test ideas. Yet, access to these materials presupposes the ability to understand written or spoken English, putting many opportunities for science learning out of reach of a large number of deaf students. Some form of close captioning mathematics concepts in ASL is needed.

Although the problem of K-8 was not addressed specifically, the need for sign language for mathematics/science concept was identified in Caccamise and Lang [Caccamise, F. and H. Lang. Signs for Science and Mathematics: A Resource Book for Teachers and Students. Rochester, N.Y., National Technical Institute for the Deaf, RIT, (1996)]. Mathematics signs available in dictionary and in video format were developed with college students in mind, but the basic mathematics concepts were also included (in addition to the basic numbers and operations that can be found in any ASL dictionary or video clips).

Further attempts have included delivering mathematics concepts via CD-ROM and the internet. Offering CD-ROM or online mathematics to deaf students in sign language may increase the mastery of mathematics concepts. In fact, it has been shown that the engagement of learners in “hands-on, minds-on” experiences may lead to in-depth understanding of mathematics/science concepts. These experiences generally have been inaccessible to students who are deaf. But if they were it is likely that their mastery of mathematics concepts would also increase since it has been shown that when students who are deaf have access to signed English pictures in association with printed test, their reading comprehension is significantly enhanced.

Although generally the only means of communication between hearing and deaf persons, there can be many disadvantages in the use of human interpreters, including: high cost, scarce availability, lack of training in educational skills, loss of privacy, no guarantee of accuracy.

On the other hand, there are many advantages in technological approaches to communication with deaf students. Most significant are assistive device technologies for enhancing access to classroom lectures in mainstream classes. One of the most exciting assistive device technologies is real time captioning.

Another important technology is direct instruction in the classroom through multimedia approaches. It comes as no surprise that when deaf adolescents are asked to rate characteristics of effective teachers, they place a high importance on the visual representation of course content during lectures. Media instruction has been advocated by effective teachers ever since the earliest forms of slide projections, films, video and CD-ROMs. Currently, to provide primary and incidental language learning experiences for deaf students, the most advanced of these new forms of media technologies is computerized animation. The current state of the art in computerized animation applied to sign language is represented, arguably, by the SigningAvatar™ by Vcom3D. SigningAvatar™ software uses computer-generated, three dimensional characters called “avatars”, to communicate in sign language with facial expressions; has a vocabulary of over 3500 English words/concepts, 24 facial expressions, and will fingerspell words not in the sign vocabulary.

Currently there are no tools specifically designed to teach ASL mathematical concepts via Interactive 3D Animation. Computer Animation applied to the education of the Deaf must address the basic problem of representing the signs with clarity, realism and emotional appeal to deaf children. While it is more accessible to the technology to produce puppet-like animations of signing characters (Vcom3D), it is worthwhile to invest the technical effort to create representations of emotionally appealing 3D signers (both realistic and fantasy) whose movements are natural and realistic.

What is needed is a method of creating a highly interactive 3D animation tool for teaching K-8 mathematical concepts.

### BRIEF SUMMARY OF THE INVENTION

In one aspect, the present invention is a method that is used with computer system having a graphical user interface including a display and a selection device. The method includes the step of retrieving a first set of elements for a first activity area and displaying the first activity area. A second set of elements for a second activity area are also retrieved and displayed. A three-dimensional avatar configured to communicate using sign language is displayed between the first activity area and the second activity area. In response to receiving a selection signal indicative of the selection device pointing at a respective element of the first set of elements, the avatar is directed to sign an expression associated with the selected element of the first set of elements.

In some embodiments, the first set activity area and the avatar may be spaced apart such that a user can visually focus simultaneously on at least a portion of the first activity area and the avatar. In other examples, the second set activity area and the avatar may be spaced apart such that a user can visually focus simultaneously on at least a portion of the second activity area and the avatar. In some cases, the first set activity area and the avatar are spaced apart such that a user can visually focus on at least a portion of the first activity area and interpret a signed communication from the avatar without any eye movement.

In other embodiments, the avatar may be configured to communicate a sign language expression by retrieving a sign language animation segment from a library containing a plurality of sign language animation segments. A portion of the sign language animation segments may be stored in the library were captured from a body capture glove or from a body capture suit.

In another aspect, the invention provides a method of teaching mathematics using sign language. A three-dimensional avatar configured to communicate using sign language is displayed on a display. A mathematical problem is presented to a user in a textual manner. Additionally, the avatar is directed to communicate the mathematical problem using sign language. In some embodiments, the avatar is directed to communicate the mathematical problem using sign language in response to receiving a selection signal indicative of a selection device pointing at the mathematical problem. In some examples, more than one possible answer to the mathematical problem is displayed and the avatar is directed to communicate the possible answers using sign language. Often, the avatar will indicate whether a proposed answer is correct using sign language. The avatar may also communicate an explanation to the mathematical problem using sign language.

According to another aspect, the invention provides a method of animating a signed communication. A first animation segment and a second animation segment configured to sign a first expression are provided, such that a signer in the first animation segment starts in a first position and a signer in the second animation segment starts in a second position. Upon receiving a request to sign the first expression, a determination is made as to whether the first expression will be an initial segment in an animation sequence. If the first expression is the initial segment in the animation sequence, first animation segment is retrieved. However, if the first expression is not the initial segment in the animation sequence, the second animation segment is retrieved.

In another aspect, the invention provides a method of creating an animation of a sign language expression. A first signal representing a range of motion during a signed expression is captured from a motion capture suit. A second signal representing a range of motion during the signed expression is captured from a motion capture glove. The first signal and the second signal are converted into an animation sequence in which an avatar communicates the signed expression.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 is an animation showing the polygonal mesh and skeletal setup of two 3D signers, on the left, and the facial rig of one of the 3D characters, on the right;

FIG. 2 is an illustration of a signer in a motion capture suit and a 3D “bunny” performing the same sign;

FIG. 3 is an illustration of the first screen of the program on the left, and the second screen on the right;

FIG. 4 shows an embodiment of a general layout of the interface for teaching how to tell time;

FIG. 5 shows an embodiment of a general layout of the interface;

FIG. 6 shows the camera controls pop-up window on the left, and two views of the signer on the right;

FIG. 7 is a screen shot of the association between the concept of a number, mathematical symbol and signed representation on the left and a screen shop of multiplication/subtraction drill mode is represented on the right;

FIG. 8 shows a screen shot of the learning mode of program aimed at hearing parents; and

FIG. 9 shows a signer with hands in neutral position (S1, E2) on the left, and a signer with hands in front of his chest at the beginning of a sign (S2) on the right.

### DETAILED DESCRIPTION OF THE DRAWINGS AND THE PRESENTLY PREFERRED EMBODIMENTS

We have focused our method on the use of 3D animation because of its unique advantages over other media (photo and video) including; user control of appearance: orientation of the image (Point of view control); location of the image relative to background (Pan and Track); Size of image (Zoom); quality of the image: no distracting details as in photos and films; user control of the speed of motion; and user programmability; unlike videotapes and CD-ROMs of video clips for which programmability is very limited (clips can be composed but with great difficulty and discontinuous results). Programmability can be utilized for: generating infinite number of drills; unlimited text encoding; real time translation; limitless combinations of signs. Further, new content development is inexpensive once authoring tools have been developed for smooth combination of signs into words and sentences. Whole sentences of signs can be linked together smoothly, without abrupt jumps or collisions between successive signs as it would happen in combining video clips. Very low bandwidth is another advantage as programs controlling animations can be stored and transmitted using only a few percent of the bandwidth required for comparable video representations. (This is not true in general but it is for specific software design such as ours.) Thus, for internet delivery, video is no match for computerized animation. In addition, character control is more refined. Signs animated on one character can be easily applied to other characters. These characters can include different human ages and ethnicity as well as cartoon characters. Hence the possibility of creating specialized characters for the need of children while using the same software developed for generic characters.

The present invention provides the design of an avatar that is used to animate signs and a prototype learning tool (interface, interactive content and coding). In some embodiments, the avatar may be three virtual signers, a female character, a male character and a fantasy character (a bunny). However, it should be appreciated that any three dimensional representation of a character with a substantially human appearance could be used, such as caricatures, comic book-like figures and cartoon characters. The platform of choice for the invention is based on the highest end in 3D Interactive Animation. It uses Maya 5.0™ (Alias/Wavefront), Filmbox and Motion Builder™ (Kaydara) coupled with Macromedia Director MX & Shockwave™ for internet delivery.

We have designed three 3D characters, a female, a male and a fantasy signer, and modeled them as continuous polygonal surfaces. In order to achieve portability to Director and high speed of response in a web deliverable environment, we have kept the polygon count of the models low (each character does not exceed 5000 polygons). To realize high visual quality with a limited number of polygons we have optimized the polygonal meshes by concentrating the polygons in areas where detail is needed the most: the hands and the areas that bend and twist (i.e., elbows, shoulders, wrists, waist). With such distribution of detail we have been able to represent realistic hand configurations and organic deformations of the skin during motion. We note that the majority of 3D avatars currently used in interactive applications for the Deaf are segmented or partially segmented therefore they do not deform realistically as they move.

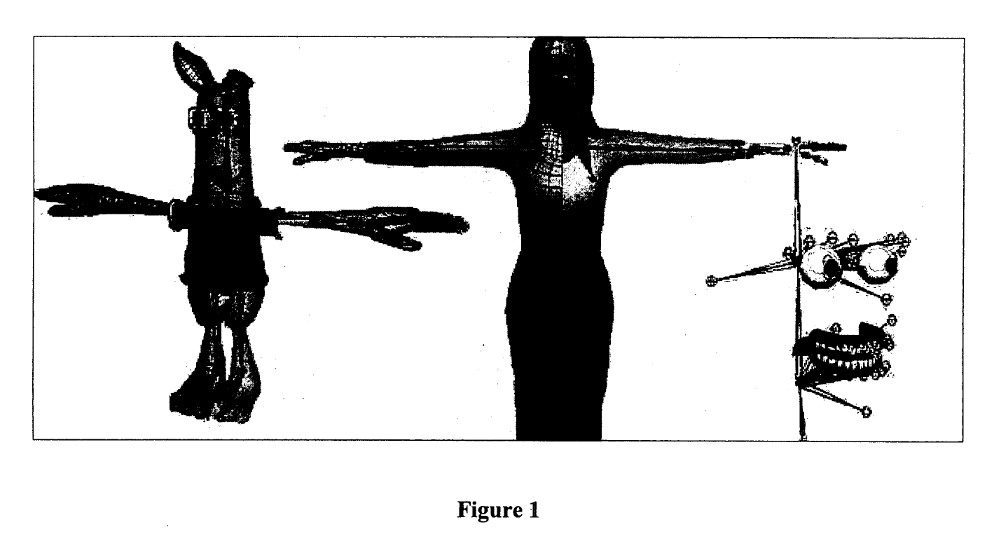

Each character has been set up for animation with a skeletal structure that closely resembles a real human skeleton. The geometry has been bound to the skeleton with a smooth skin and the skin weights have been edited to optimize the deformation effects. The face of each 3D signer has been rigged with bone deformers, the only technique supported by the 3D Shockwave exporter. To produce natural facial expressions the 40 joints of the facial rig have been positioned so that they deform the digital face along the same lines pulled and stretched by the muscles of a real human face. FIG. 1 shows the polygonal mesh and skeletal setup of two of the virtual signers, on the left, and the facial rig of one of the signers, on the right.

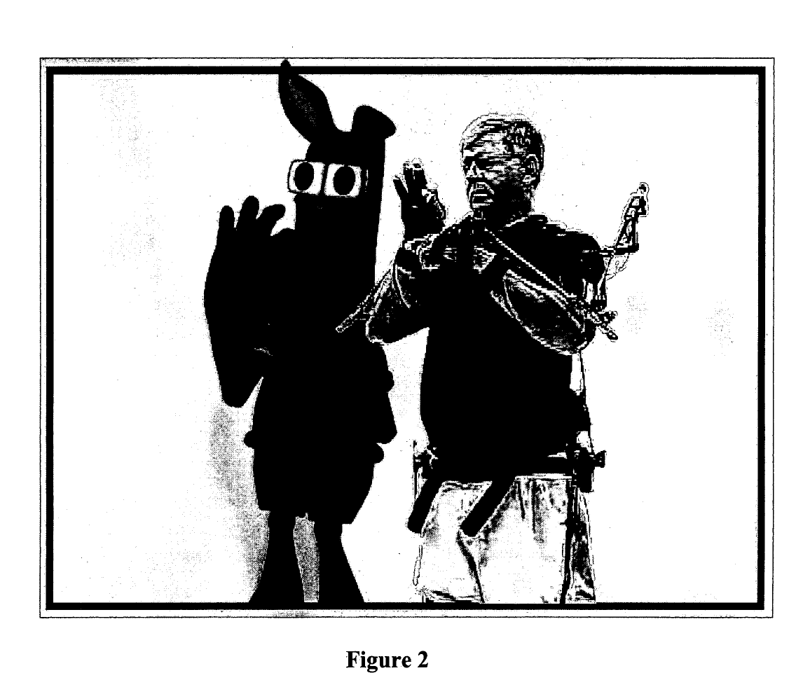

The signs for mathematics terminology have been performed by a deaf signer and captured with a Gypsy 3.0 wired motion capture suit and a pair of 18-sensor Metamotion Cybergloves (see FIG. 2). Both devices interface with Kaydara Filmbox™ software and allow for real-time motion capture. Since both the gloves and the suit are mechanical devices, meaning they use rotation sensors as opposed to optical systems, the major difficulty faced during the capturing of the motion has been the calibration procedure. Calibrating is the process of adjusting the reading of each motion sensor to fit the geometrical parameters of the person wearing the suit. Even with an accurate calibration, when applying the recorded motion to the 3D characters, we have faced problems of slight motion inaccuracy and surface penetration. These problems are due primarily to the geometrical differences (i.e., length of fingers, arms, spine, etc.) between the real signer and the 3D characters. We have come to a solution by adding a layer of keyframed animation to the motion captured data. Adding keyframe animation in a non-destructive manner is a common method used to fine tune the motion and avoid intersection of body parts.

Realistic appearance of the signs (in terms of motion, hand shape, and orientation) and natural in-between movements (movement epenthesis) are both crucial to conveying the realism and structure of the signed representation. Motion capture technology has allowed us to produce realistic representations of each individual sign. Programmable blending of the animation segments, performed with the guidance and feedback of a signer, has provided us with an efficient method of creating natural in-between movements between words being signed.

The prototype learning tool contains two programs: program (1) is aimed at deaf children and program (2) is aimed at hearing parents. Each program has two modes of operation: (1) a learning mode and (2) a practice/drill mode. The two modes of usage are characterized by different color schemes (yellow for learning and orange for testing). The color differentiation allows children to easily choose and remember the type of activity.

One of the challenges faced during the design of the interface has been the need to provide the deaf child with non-textual menu items and navigational buttons. As mentioned previously, the majority of deaf children do not become proficient in reading English until grades 5-6. Therefore, we have created iconic representations of each selection and navigation item (in some cases we also provide signed representations). After using the program a few times, the child can easily memorize and remember the graphical representations corresponding to different math activities and therefore use the tool on her own, without the help of a teacher or parent.

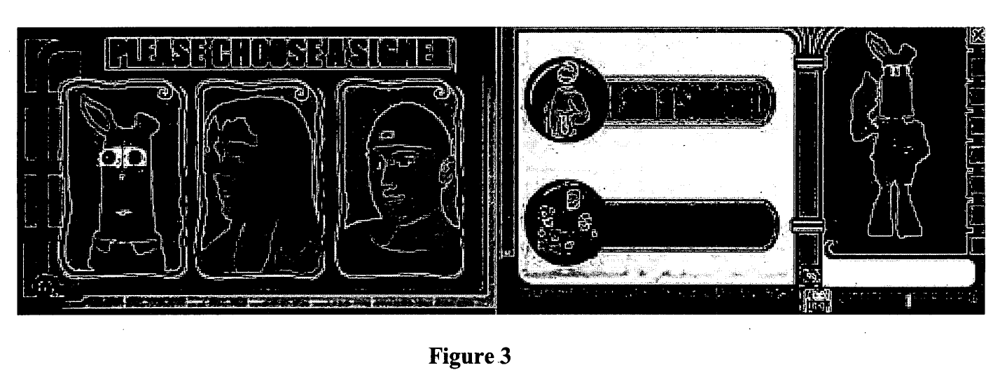

The first screen of the interface allows the user to select one of the three virtual signers and the second screen lets her choose one of the two programs (Screens 1 and 2 are represented in FIG. 3).

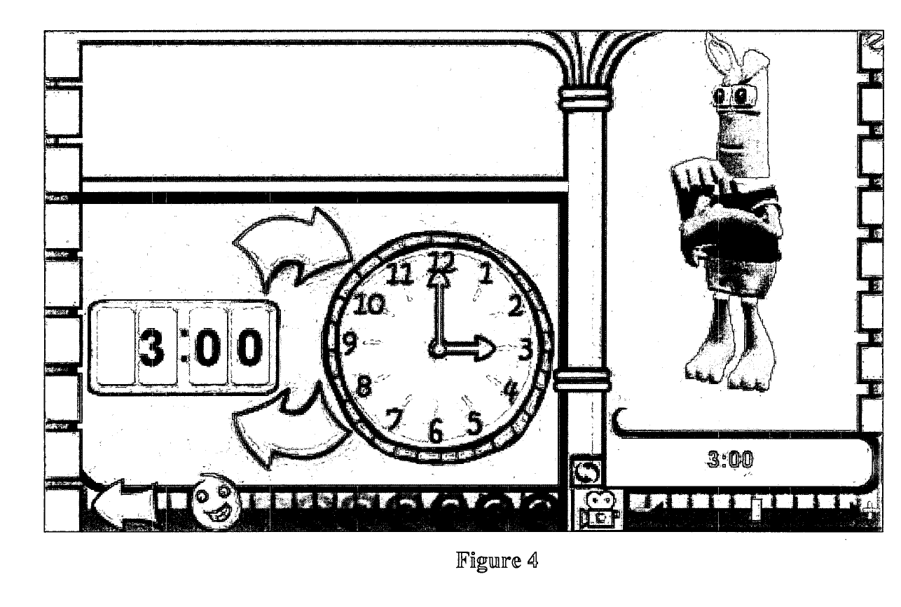

Each screen presents a consistent layout and visual style. In some examples, the screen layout may include two frames, as shown in FIG. 4. In the example shown in FIG. 4, the frame on the left is used to select the grade (k-1, 2 or 3) and/or the type of activity. The frame on the right is occupied by the 3D signer (FIG. 4). The upper area of the frame on the left (in green) is used to give textual feedback on the current activity, the bottom area contains the navigational buttons. The frame on the right contains a white text box, right below the signer, used to show the answer (in mathematical symbols) to the current problem. Below the answer box there is a camera icon and a slider represented by an arrow. The slider is used to control the speed of signing, the camera button opens a popup menu used to zoom in/out on the 3D signer, change the point of view and pan to the left or to the right within the 3D signer window.

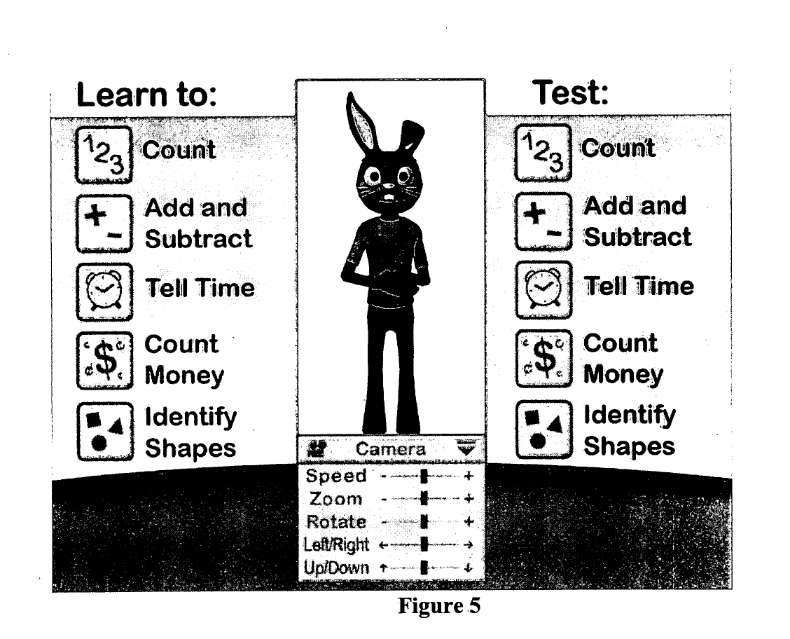

In other examples, the screen layout may include three frames, as shown in FIG. 5. With this layout, the tasks of learning and testing are more clearly separated. More importantly, the avatar is now placed in the middle of the screen and activity areas, such as the learning and testing activities, are placed on the left and right sides, respectively. The viewer can now fully attend to the center of the screen and use her peripheral vision to see the other two frames (containing the buttons/activities). Instead of a constant shift of gaze between the avatar and the buttons/activities, the spatial relationship between the activity areas is such that the user can focus on one of the activity areas while still understanding the signed communication from the avatar.

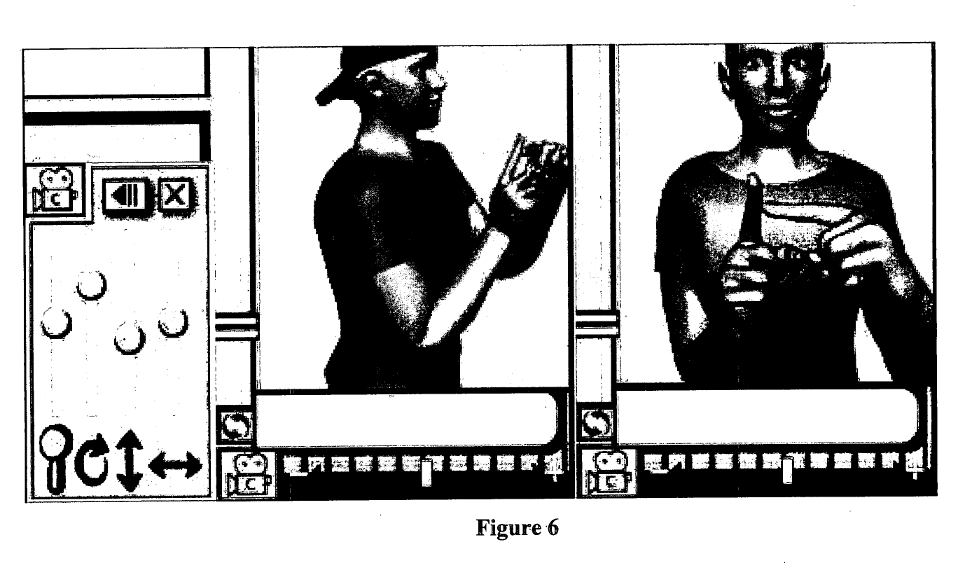

We note that different views of the signer's hands and arms while signing are necessary for effective practice and learning. For example, the front and two side views are the views generally observed in conversation, while the point of view of the signer is useful when learning how to sign. In order to acquire proficiency in signing it is important to be able to observe one's own hands and arms in the process of producing the correct signs. For this reason we have provided a tumble tool which allows a 360 degrees rotation of the camera around the signer. FIG. 6 shows the camera controls pop-up window with two different views of the signer. Another point worth noting is the ability to control the speed of signing. For the beginner (i.e., a hearing parent of a deaf child) observing people signing at natural speed, the signs usually cannot be resolved—the motion of the fingers appearing as a moving blur.

The situation is entirely analogous to the learning of a foreign language. The beginner usually finds it impossible to resolve the words spoken at natural rate of speech. So she needs to practice with language spoken at a lower rate until, by gradually increasing the rate of speech, she becomes able to resolve words spoken at natural rate. For this purpose, videotapes are of no help whereas computer based language programs provide a convenient way of controlling rate of speech and hence gradually getting accustomed to the natural flow of sounds. Superficially, it may appear that the situation is different for sign language since videotape rate can be reduced without distortion (contrary to what happens in reducing the tape speed for sound), but in practice the speed reduction is for a few fixed values and it is awkward to operate. Only DVDs and animation can provide this control. However DVDs are limited in the range of drills that can be offered to the student, whereas computer driven animation can provide an endless source of different drill exercises. The speed control in our program ranges from 1 to 60 frames/sec so that finger spelling can be practiced from very low speed to up to twice the natural rate.

We have taken the mathematics vocabulary from the list of mathematics signs developed by Caccamise & Lang in the work that remains the standard for signs for mathematics terminology. We have divided the list in eight groups in approximately ascending order of abstraction level corresponding to the eight grades (K-1 to 8). We note that the vocabulary is actually more extensive than needed up to 8th grade in today's US schools; thus it can be utilized also for high school and beyond.

As mentioned earlier, while we have produced the animations corresponding to all K-8 mathematical signs, the development of interactive content has been so far limited to grades K-3. One of the advantages of using 3D animation is that new content development is inexpensive once authoring tools have been created. Therefore, expansion of the interactive content to include mathematical concepts for grades 4-8 is expected to be easy to implement.

In the grade K-1 section of Program (1) the child learns: (1) the concept of number; (2) addition and subtraction (limited to 1 digit numbers), (3) time and (4) money. In the grade 2 section the child learns: (1) addition and subtraction (up to 2 digits numbers); (2) multiplication and division (limited to 1 digit numbers); (3) Plane figures. In the grade 3 section the student is introduced to: (1) multiplication and division (2 digits numbers); (2) solid figures; (3) measure; (4) fractions; (5) decimals.

For each topic we have designed a series of interactive activities, to help the child understand the concept and test her skills. Every mathematical concept is signed by the 3D character of choice and also represented in mathematical symbols.

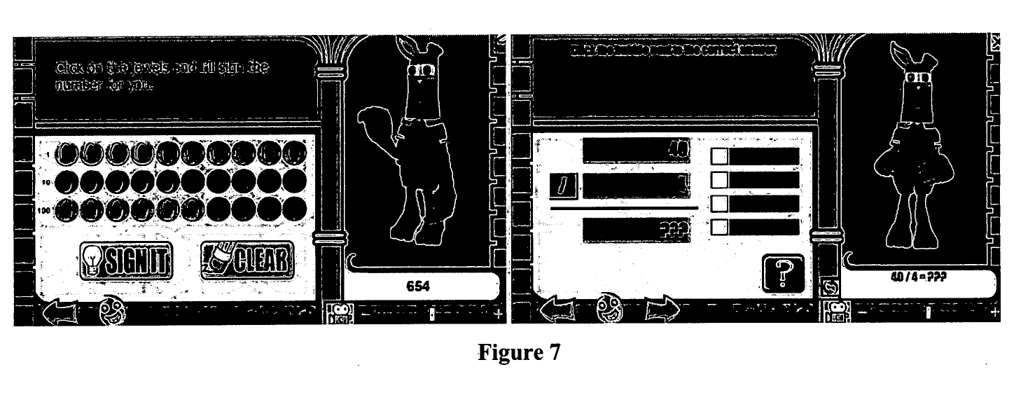

For instance, in K-1 learning mode, the child practices the association between the concept of the number, the mathematical symbol, and the signed representation. Using an on-screen iconic representation of the number concept, the child selects which number (zero to one thousand) should appear in mathematical symbol(s) and signed. FIG. 7 shows two screen shots of the program. In the screen shot on the left the three rows of “jewels” in the middle of the left frame are conceptual representations of the numbers 1 to 1000. The upper row (yellow) represents units, the middle row (blue) represents tens and the lower (red) represents hundreds. The child clicks on the “jewels” to produce a number. Clicking on the “Sign it” button produces the symbol representing the number (displayed in the white textbox right below the signer) and causes the virtual signer to sign the number.

In practice drill mode of grade 2, for example, the child chooses the operation to drill on and the program generates a random question signed by the 3D signer and presented in math symbols, along with four possible answers (See FIG. 7 on the right). The child can mouse-select one of the four answers or click on the question mark button to reveal the solution. Based on the selected choice, the signer gives positive or negative feedback (by signing yes/no) and signs the entire operation with the correct answer. The answer is also displayed in mathematical symbols. Similar interactive activities have been developed to learn other mathematical concepts such as time and money.

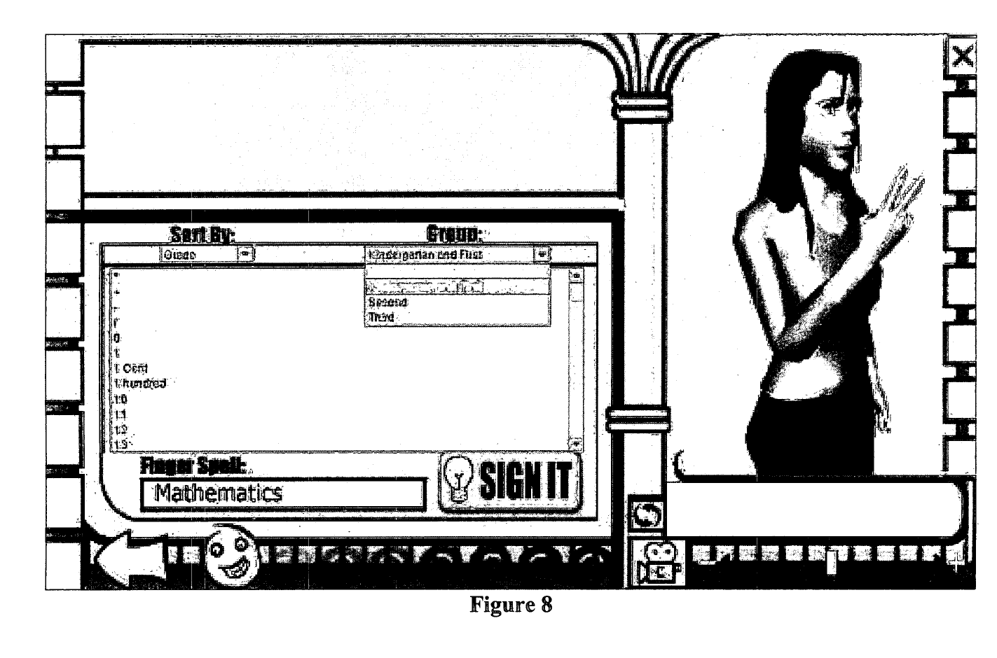

In program (2) (aimed at hearing parents of deaf children), in learning mode, the user selects a math concept and the 3D signer signs it. The mathematical signs can be sorted alphabetically, by category (i.e., measure, money, numbers etc) or by grade (see FIG. 8). In practice/drill mode the user chooses which category of math signs to be tested on. The signer signs a mathematical concept and the program outputs 4 possible answers. After the user chooses the answer, the 3D signer gives positive or negative feedback and signs the answer. In addition, the user can type any word in the Fingerspelling text box and, by pressing the “Sign it” button, have the signer fingerspell it.

Content and relative signs can be easily added to the interactive program. The tool is easily customizable to suit different teaching styles and needs. Integrating new activities requires nothing more than adding a few lines of code.

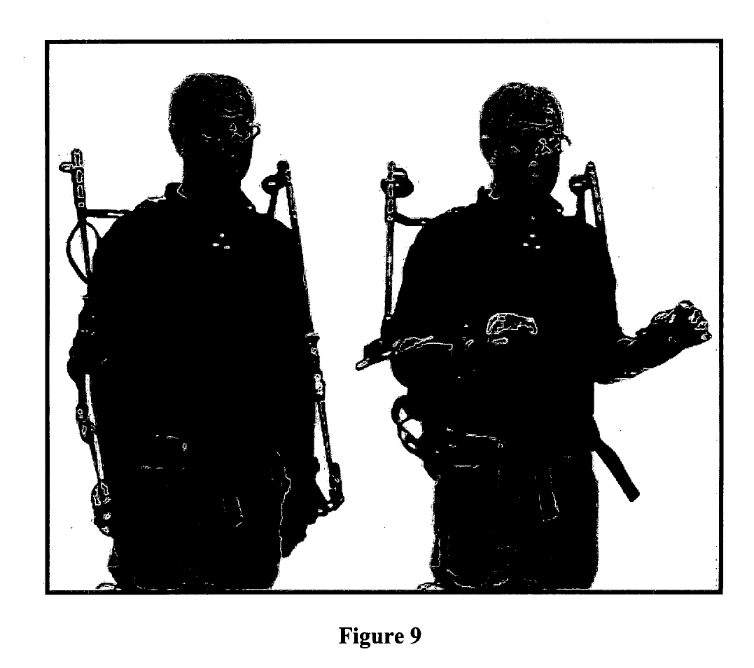

As mentioned earlier, interactivity and smoothness of motion have been realized via programmable blending of the animation clips. In order to blend the animation segments relative to different signs, each individual sign has been captured so that it starts and ends with the signer's hand(s) in the neutral position (see FIG. 9 on the left). The signs have been organized in groups (i.e., letters, numbers, arithmetic processes, etc.) and each group of signs has been saved as a separate file. We have created an XML file which stores information about each animated sign. The XML entry for each sign contains the group name, sign name, start and end times, grade level, and play rate. Whenever the avatar is asked to sign a particular math concept, the program finds the sign's entry, and retrieves the corresponding animated segment with its start and end times. Each sign has two start and two end positions. The first start position (S1) has the signer with the hand(s) in the neutral pose, the second start position (S2) has the signer with the hand(s) in front of his chest, first frame of the sign (see FIG. 9 on the right). The first end position (E1) has the signer with the hand(s) in front of his chest, last frame of the sign, the second end position (E2) has the signer with the hand(s) in the neutral pose. For example, when the user asks the avatar to sign the equation “3+5=8”, the program uses (S1) and (E1) for the sign of number 3; (S2) and (E1) for the signs of +, 5 and =; and (S2) and (E2) for the sign of number 8.

The technique described above allows, not only to create smooth transitions between signs, but also to maintain a consistent signing area throughout the signing motion.

In this regard, the need of increasing the effectiveness of (hearing) parents in teaching arithmetic skills to their deaf children and the opportunity of deaf children to learn arithmetic via interactive media has been considered. The invention focuses on 3D animation as the technology of choice since it offers unique advantages such as: (1) user control of appearance of the signer; (2) user control of speed of motion; (3) user programmability; (4) web deliverability (low bandwidth); (5) smooth combination of signs in words and sentences; (5) possibility of creating realistic/fantasy/specialized characters.

To summarize, using Macromedia Director MX/Maya3D Shockwave Exporter 1.5 we have produced a tool for learning how to sign K-8 mathematical concepts and for teaching K-3 arithmetic skills to deaf children in a highly interactive and media reach context.

We have used Maya 5.0 to model three seamless 3D signers and we have rigged them with a skeletal deformation system which allows natural deformations of the skin during motion.

To achieve clarity and realism of motion, the signed representations of all mathematical concepts have been performed by a non-hearing signer and the motion has been captured with a highly accurate motion capture suit. The motion data have been fine tuned and applied to the virtual signers and the animated representations of the signs have been exported to Director via the 3D Shockwave exporter. Macromedia Director MX and Shockwave Studio have provided an efficient platform for creating a variety of interactive math activities and for web delivery.

One of the biggest challenges is realization of an extremely clear and natural representation of the signs. Realistic, non-mechanical or contrived motion is fundamental not only to learning sign language effectively, but also to the reinforcement of the deaf child's self esteem and self-concept. We have tested the program with 3 signers who have provided us with feedback on the readability and realism of the signs. Their positive feedback has confirmed the achievement of a natural gesture language by computer animation. Such achievement is an improvement on the technologies so far adopted for computer animation applied to the education of deaf children.

The broader impact of the present invention lies in promoting the learning of K-8 math skills for deaf children so they can enter careers in science and technology. It paves the way for improved methods of teaching mathematics in public schools, possibly affecting the infrastructure of interpreted teaching of math by shifting to a more interactive media based instruction. Ultimately the benefit to society will be the further communication and understanding among the two communities of the hearing and not-hearing people.

It is therefore intended that the foregoing detailed description be regarded as illustrative rather than limiting, and that it be understood that it is the following claims, including all equivalents, that are intended to define the spirit and scope of this invention.

What is claimed is:

1. In a computer system having a graphical user interface including a display and a selection device, a method comprising:
retrieving a first set of elements for a first activity area;
retrieving a second set of elements for a second activity area;
displaying the first activity area;
displaying the second activity area;
displaying a three-dimensional avatar configured to communicate using sign language on the display between the first activity area and the second activity area;
receiving a selection signal indicative of the selection device pointing at a respective element of the first set of elements;
in response to the selection signal, directing the avatar to sign an expression associated with the selected element of the first set of elements.

2. The method of claim 1, where the first activity area and the avatar are spaced apart such that a user can visually focus simultaneously on at least a portion of the first activity area and the avatar.

3. The method of claim 1, where the second activity area and the avatar are spaced apart such that a user can visually focus simultaneously on at least a portion of the second activity area and the avatar.

4. The method of claim 1, where the first activity area and the avatar are spaced apart such that a user can visually focus on at least a portion of the first activity area and interpret a signed communication from the avatar without any eye movement.

5. The method of claim 1, further comprising displaying an explanation of a function associated with at least one element of the first set of elements using sign language.

6. The method of claim 1, where the avatar is configured to communicate a sign language expression by retrieving a sign language animation segment from a library containing a plurality of sign language animation segments.

7. The method of claim 6, where at least a portion of the sign language animation segments stored in the library were captured from a motion capture glove.

8. The method of claim 7, where at least a portion of the sign language animation segments stored in the library were captured from a motion capture suit.

9. In a computer system having a graphical user interface including a display and a selection device, a method of teaching mathematics using sign language comprising:
displaying a three-dimensional avatar configured to communicate using sign language on the display;
retrieving a mathematical problem;
displaying the mathematical problem on the display in a textual manner; and
directing the avatar to communicate the mathematical problem using sign language.

10. The method of claim 9, further comprising receiving a selection signal indicative of the selection device pointing at the mathematical problem and in response to the signal, directing the avatar to communicate the mathematical problem using sign language.

11. The method of claim 9, further comprising displaying more than one possible answer to the mathematical problem and directing the avatar to communicate the possible answers using sign language.

12. The method of claim 9, where in response to receiving a proposed answer to the mathematical problem from a user, determining whether the proposed answer is correct and directing the avatar to indicate whether the proposed answer is correct using sign language.

13. The method of claim 12, further comprising retrieving an explanation associated with the mathematical problem and directing the avatar to communicate the explanation using sign language.

14. The method of claim 9, where the mathematical problem is selected from the group consisting of addition, subtraction, division and multiplication.

15. A method of animating a signed communication:
providing a first animation segment configured to sign a first expression, where a signer in the first animation segment starts in a first position;
providing a second animation segment configured to sign the first expression, where a signer in the second animation segment starts in a second position;
receiving a request to sign the first expression;
determining whether the first expression will be an initial segment in an animation sequence,
if the first expression is the initial segment in the animation sequence, retrieving the first animation segment, and
if the first expression is not the initial segment in the animation sequence, retrieving the second animation segment.

16. The method of claim 15, where the first position is a neutral pose.

17. The method of claim 15, where the signer has a chest and where in the second position the signer has at least one hand in front of the chest.

18. The method of claim 15, further comprising:
providing a third animation segment configured to sign the first expression, where a signer in the third animation segment starts in a third position;
providing a fourth animation segment configured to sign the first expression, where a signer in the fourth animation segment starts in a fourth position;
determining whether the first expression will be a final segment in an animation sequence;
retrieving the third animation segment if the first expression is a final segment in an animation sequence.

19. The method of claim 18, further comprising retrieving the fourth animation segment if the first expression is not the final segment in the animation sequence.

20. A method of animating a signed communication, the method comprising:
providing a library of sign language expressions, each expression associated a first animation segment, a second animation segment, a third animation segment and a fourth animation segment, where a signer in the first animation segment starts in a first position and ends in the first position, where a signer in the second animation segment starts in a second position and ends in the second position, where a signer in the third animation segment starts in the first position and ends in the second position and a signer in the fourth animation segment starts in the second position and ends in the first position;
receiving a request for a signed communication, the signed communication including an initial expression, an intermediate expression and a final expression;
retrieving the first animation segment for a sign language expression corresponding to the initial expression from the library;
displaying the first animation segment on a display;
retrieving the fourth animation segment for a sign language expression corresponding to the intermediate expression from the library;
displaying the fourth animation segment on the display;
retrieving the second animation segment for a sign language expression corresponding to the final expression from the library; and
displaying the second animation segment on the display.

21. A method of creating an animation of a sign language expression, the method comprising:
capturing a first signal from a motion capture suit, the first signal representing a range of motion during a signed expression;
capturing a second signal from a motion capture glove, the second signal representing a range of motion during the signed expression;
converting the first signal and the second signal into an animation sequence in which an avatar communicates the signed expression.
